(19) United States
(12) Patent Application Publication
(10) Pub. No.: US 2013/0233307 A1
(43) Pub. Date: Sep. 12, 2013

(54) SOLUBLE SUGARS PRODUCED ACCORDING TO A PROCESS OF NON-AQUEOUS SOLID ACID CATALYZED HYDROLYSIS OF CELLULOSIC MATERIALS

(71) Applicant: University of Central Florida Research Foundation, Inc., Orlando, FL (US)

(72) Inventors: Richard G. Blair, Oviedo, FL (US); Sandra M. Hick, Oviedo, FL (US); Joshua H. Truitt, Orlando, FL (US)

(21) Appl. No.: 13/799,432

(22) Filed: Mar. 13, 2013

Related U.S. Application Data
(63) Continuation-in-part of application No. 12/621,741, filed on Nov. 19, 2009.
Application No. 12/621,741 is a continuation-in-part of application No. PCT/US08/82386, filed on Nov. 5, 2008.
(60) Provisional application No. 61/721,316, filed on Nov. 1, 2012.

(51) Int. Cl. C13K 13/00

(52) U.S. Cl. CPC C13K 13/00
USPC 127/30; 127/37

(57) ABSTRACT

The presently disclosed and/or claimed inventive concept(s) relates generally to processes for the non-aqueous hydrolysis of cellulose-containing material, and, more particularly but without limitation, to processes for the non-aqueous hydrolysis of cellulose-containing material into soluble sugars using a solid acid material as a catalyst. Further, the presently disclosed and/or claimed inventive concept(s) relates to non-aqueous and/or powdered soluble sugars and reaction products containing such non-aqueous and/or powdered soluble sugars produced according to a non-aqueous hydrolysis of cellulose-containing material using a solid acid material as a catalyst.

### CROSS-REFERENCE TO RELATED APPLICATIONS/INCORPORATION BY REFERENCE STATEMENT

The present application is a continuation-in-part of U.S. Ser. No. 12/621,741, filed Nov. 19, 2009, entitled “SOLID ACID CATALYZED HYDROLYSIS OF CELLULOSIC MATERIALS”; which claims priority to PCT/US08/082,386, filed Nov. 5, 2008; which claims priority to U.S. Ser. No. 11/935,712, filed Nov. 6, 2007, now issued as U.S. Pat. No. 8,062,428; the entire contents of each of which is hereby expressly incorporated herein by reference. The present application also claims benefit under 35 U.S.C. 119(e) of U.S. Provisional Application Ser. No. 61/721,316, filed Nov. 1, 2012, entitled “SOLUBLE SUGARS PRODUCED ACCORDING TO PROCESS OF NON-AQUEOUS SOLID ACID CATALYZED HYDROLYSIS OF CELLULOSIC MATERIALS”; the entirety of which is hereby expressly incorporated herein by reference.

### BACKGROUND

1. Field of the Inventive Concept(s)

The presently disclosed and/or claimed inventive concept(s) relates generally to processes for the non-aqueous hydrolysis of cellulose-containing material and, more particularly but without limitation, to processes for the non-aqueous hydrolysis of cellulose-containing material into soluble sugars using a solid acid material as a catalyst. Further, the presently disclosed and/or claimed inventive concept(s) relates to non-aqueous and/or powdered soluble sugars and reaction products containing such non-aqueous and/or powdered soluble sugars produced according to a non-aqueous hydrolysis of cellulose-containing material using a solid acid material as a catalyst.

2. Background of the Inventive Concept(s)

Ethanol is the most widely used liquid biofuel in the world. In the U.S., ethanol is typically used as a gasoline additive and is blended into gasoline at up to 10 percent by volume to produce a fuel called E10 or “gasohol.” In 2005, total U.S. ethanol production alone was 3.9 billion gallons, or 2.9 percent of the total gasoline pool. In 2006, that number increased to 4.86 billion gallons and is well on pace to further rise in the future. Therefore, the efficient and inexpensive production of materials to produce ethanol is of great interest.

One source of feedstock material to produce ethanol is soluble sugars produced by hydrolyzing cellulose. Lignocellulosic biomass (i.e., a “cellulose-containing material”) represents a rich source of feedstock for the production of soluble sugars for use in fuels and chemicals. Although biological sources such as switch grass, corn stover, bagasse, and other agricultural waste are easily and cheaply obtained, these materials are largely underutilized as raw materials for ethanol production due to the processing demands required for conversion. If these materials could be efficiently processed into soluble sugar starting materials, the environmental impact from the burning or landfilling of waste cellulosic materials can be reduced. Additionally, the production of economically valuable soluble sugars is an economically beneficial outcome. Additional exemplary types of biomass materials which contain cellulose include wood, paper, agricultural residues, industrial solid wastes, and herbaceous crops.

Currently, cellulose-containing biomass is processed in one of three ways: acid hydrolysis, enzymatic hydrolysis, and pyrolysis. Generally, hydrolysis processes are characterized by the breaking of the bonds between the glucose monomer units of cellulose to provide soluble sugar moieties, which are fermentable into ethanol. Two hydrolysis methods are commonly used: acid hydrolysis and enzymatic hydrolysis. However, neither process is optimal. While acid hydrolysis can be performed with dilute or concentrated acid, dilute acids require high temperature and pressures while concentrated acids must be removed from the reaction product before fermentation of the soluble sugars can occur.

Enzymatic processes require a stable supply of enzymes and pretreatment in order to more easily hydrolyze cellulose, especially when the cellulose is in the form of a lignocellulosic material. As set forth in U.S. Pat. Nos. 6,419,788 and 4,461,648 (the entire contents of which are expressly incorporated herein by reference in their entirety), for example, because of the complex chemical structure of lignocellulosic material (which includes lignin and hemicellulose that coat the cellulose) microorganisms and enzymes cannot effectively attack the cellulose without prior treatment. Such prior treatment makes the cellulose accessible to the enzymes or bacteria used for fermentation. Additionally, enzymes and microorganisms have limited pressure/temperature regimes in which they can function and such systems are difficult to effectively manage. Although new biological and chemical approaches seek to circumvent the drawbacks associated with these processes, none have proven to be especially useful in commercial quantities and/or scale up. The inventors herein describe, however, a novel and non-obvious catalytic process for the depolymerization of a cellulose-containing material into a solid and/or powdered reaction product containing soluble sugars.

Catalytic processing of lignocellulosic material is an important topic and although efficient catalysts have been developed for a wide range of heterogeneous systems, they are ill suited for a solid non-aqueous catalysis process. One major drawback of previously known catalysts involves mass transport: the high surface area structures that are uniquely suited to liquid and gas catalysis processes are not efficient and/or practical for use in a solid non-aqueous process. Two typical catalysts, porous solids and supported particles for example, have significant limitations when applied to a solid non-aqueous catalyst system. Porous solids have pore sizes too small to accommodate molecules much larger than 30 Å and supported particle systems still require some method to overcome the solid-solid diffusion barrier necessarily present in non-aqueous solid catalyst systems. As the solid-solid diffusion barrier (mass transport) must be overcome and the catalyst must be structured so as to allow access to catalytic sites, such prior art catalytic depolymerization processes for cellulose-containing materials must necessarily involve solvent systems to overcome the diffusion barrier.

A catalyst system is herein disclosed that overcomes such diffusion difficulties in a non-aqueous catalyzed reaction by using mechanical force without the addition of solvents—i.e., a mechanocatalysis or tribocatalysis process. Contrary to the process disclosed herein, recent research in the field has focused on using traditional heterogeneous catalysts (such as zeolites) in mechanocatalysis processes. The use of such heterogeneous catalysts is inefficient, however, due to the aggressive nature of mechanical processing. Effective mechanocatalysts need to be mechanically robust and still possess sites that are physically accessible and chemically active.

The mechanocatalytic process disclosed herein requires no external heat. All of the energy for the reaction comes from the pressures and frictional heating provided by the kinetic energy of milling media moving in a container. In the mechanocatalytic process herein disclosed, intimate contact between the catalyst and the reactant is maintained. As disclosed herein, pebble (or rolling) mills, shaker mills, attrition mills, and planetary mills are a few examples of mills that effectively “push” the catalyst into contact with the material being treated (e.g., biomass) and can be used with the mechanocatalytic process disclosed herein to produce soluble sugars from a cellulose-containing material such as lignocellulose.

### SUMMARY OF THE INVENTIVE CONCEPT(S)

The inventors have unexpectedly found that when a solid acid material is combined with a cellulose-containing material and agitated in a non-aqueous environment, a high yield of soluble sugars can be produced. In the process, the agitation of the material, typically in a mill, provides the kinetic energy necessary to drive the hydrolysis reaction while the solid acid material has a surface acidity that aids in hydrolyzing the glycosidic bonds of the cellulose material. In addition, when the solid acid material has a sufficient existing water content, the water of the solid acid material can provide the water necessary for the hydrolysis reaction without the need for added water—i.e., the hydrolysis reaction is non-aqueous. For example, in one embodiment of the presently disclosed and/or claimed inventive concept(s), the solid acid material is a material, such as kaolin or bentonite, which has a surface acidity as well as a water content. The resulting products of the hydrolysis reaction, which include a quantity of soluble and fermentable sugars (in a solid and/or powdered state), are useful in the production of ethanol and for other purposes.

Moreover, the inventors have found that when the cellulose-containing material is a lignocellulosic material, the solid acid material also hydrolyzes the hemicellulose and lignin components of the lignocellulosic material as well as the cellulose. Hemicelluloses are non-cellulosic polysaccharides that are built up mainly of sugars other than glucose, i.e. D-xylose with other pentoses and some hexoses with β-linkages. They are generally poorly ordered and non-crystalline and have a much lower chain length than cellulose. Lignin is an aromatic polymer, phenolic in nature, and built up from phenylpropane units, but with no systematic structure. Thus, when the cellulose-containing material is a lignocellulosic material, the hemicellulose and lignin of the material can also be decomposed into useful products, namely further soluble sugars and aromatic hydrocarbons, such as vanillin, respectively. In this way, the presently disclosed and/or claimed inventive concept(s) eliminate waste from the hydrolysis of lignocellulosic material, as well as eliminate the need to pre-treat the cellulose material before hydrolyzing the lignocellulosic material, as in known processes. In accordance with one aspect of the presently disclosed and/or claimed inventive concept(s), there is provided a method for the production of soluble sugars from a cellulose-containing material, comprising: (a) contacting the cellulose-containing material with a solid acid material; and (b) agitating the cellulose-containing material and the solid acid material for a time sufficient to produce a reaction product comprising soluble sugars in a solid and/or powdered form. The cellulose-containing material may be a pure cellulose material or any other type of cellulose-containing material, such as a biomass or lignocellulosic material. The solid acid material may be any type of solid or semi-solid material having a surface acidity, defined as H₀, with a value of less than about −3.0, and more preferably less than about −5.6.

Optionally, the above-described method may further comprise: (c) after the step of agitating, recovering a second aqueous solution comprising soluble sugars by rinsing the solid acid material and the cellulose-containing material with an aqueous solution. In addition, since the solid acid material is not a reactant in the hydrolysis process, after the step of recovering, the process optionally further comprises: (d) reusing and/or recycling a quantity of the solid acid material back to the reactor and repeating steps (a) and (b), and optionally (c) above, with additional “fresh” or additional cellulose-containing material. The process may be performed within a mill or any other suitable vessel that provides agitation of the material therein.

In accordance with another aspect of the presently disclosed and/or claimed inventive concept(s), there is provided a method for the production of soluble and fermentable sugars from a cellulose-containing material, comprising:

(a) contacting the cellulose-containing material with a solid acid material; and

(b) agitating the cellulose-containing material and the solid acid material for a time sufficient to produce a product comprising soluble sugars, wherein agitating occurs at a temperature of between about −5 to about 105 degrees Celsius, and wherein said cellulose-containing material and solid acid material have a combined free water content of about 45% or less. The reaction products of those processes contain soluble sugars in a solid and/or powdered form. Thereafter, the method optionally includes steps (c) and (d) as described above.

Thus, the presently disclosed and/or claimed inventive concept(s) also contemplates that certain types of solid acid materials may inherently have a water content that enables the hydrolysis of the cellulose-containing material to occur without the need for added water. This water may be present as water of crystallization of the solid acid material or materials therein, or as absorbed or adsorbed water of the solid acid material (referred to as the “free water content” below). At least a portion of the water of crystallization may be removed during the steps of agitating as described herein. Moreover, water necessary for the hydrolysis of the cellulose may be provided by any moisture or water contained in the cellulose-containing material. In addition, in the hydrolysis of cellulose, a dehydration of glucose may take place to provide further water for the hydrolysis reaction. As such, the hydrolysis reaction is disclosed as occurring in a non-aqueous medium—i.e., the water content of the solid acid material and the cellulose-containing material is less than or equal to 45% by weight.

In accordance with another aspect of the presently disclosed and/or claimed inventive concept(s), during the step (b) of agitating, the free water content of the solid acid material is in the range of about 4% to about 10% by weight of the solid acid material. The free water content of the cellulose-containing material and the solid acid material is collectively less than about 45% by weight, and preferably from about 8% to about 40% by weight, so as to not undesirably lower the kinetic energy needed for the hydrolysis reaction upon agitating. By “free water content,” it is meant an amount of water in the cellulose-containing material and solid acid containing material that is contained within the cellulose-containing material and the solid acid material, but does not pertain to a water of hydration or crystallization of either material. In this way, there is sufficient water in the mixture to drive the hydrolysis reaction.

In accordance with yet another aspect of the presently disclosed and/or claimed inventive concept(s), the solid acid material is an aluminosilicate material, such as a clay material. The clay material may be any one of kaolin, bentonite, fuller's earth, or an acid-treated clay material, such as acid-treated bentonite treated with about 1 M hydrochloric acid. When the solid acid material is a clay material, the clay material may have a water content that is attributable to a water of crystallization of the material or materials therein. The water of crystallization may be removed during agitating to further provide needed water for the hydrolysis reaction.

In accordance with still another aspect of the presently disclosed and/or claimed inventive concept(s), the solid acid material is a solid superacid material. Superacids may be defined as acids stronger than 100% sulfuric acid (also known as Brönsted superacids). In addition, superacids may be described as acids that are stronger than anhydrous aluminum trichloride (also known as Lewis superacids). Solid superacids are composed of solid media that are treated with either Brönsted or Lewis acids. In one embodiment, the solid acid is a solid superacid comprising alumina treated with 2 M sulfuric acid, filtered and calcined at about 800° C. for about 5 hours.

In accordance with another aspect of the presently disclosed and/or claimed inventive concept(s), the ratio of the cellulosic-containing material to the solid acid material is from about 0.5:1 to about 10:1. When the solid acid material is a clay material, in one embodiment, the ratio of the cellulosic material to the solid acid material may be provided in the range of from about 1:1 to about 3:1 because the clay material contains a free water content, as well as water of crystallization.

In accordance with another aspect of the presently disclosed and/or claimed inventive concept(s), the cellulose-containing material is a lignocellulosic material. As a result of the steps (a) and (b) of contacting and agitating in any embodiment described herein, the hemicellulose is hydrolyzed into a quantity of soluble sugars and the lignin is decomposed into useful aromatic hydrocarbons, such as vanillin. The soluble sugars from the hydrolysis of hemicellulose and the produced aromatic hydrocarbons may be recovered in a reaction product after the step of agitating from the cellulose-containing material and the solid acid material. This reaction product may also comprise soluble sugars from the hydrolysis of cellulose. In addition, the reaction products may be rinsed with an aqueous solution to produce an aqueous solution comprising soluble sugars, as well as the aromatic hydrocarbons. The solid acid material remaining in the reaction products may thereafter be reused and/or recycled back to step (a) to hydrolyze further lignocellulosic material alone or in combination with “fresh” or make up solid acid material.

Polysaccharides are long carbohydrate molecules of repeated monomer units joined together by glycosidic bonds. They range in structure from linear to highly branched. Polysaccharides are often quite heterogeneous, containing slight modifications of the repeating unit. Polysaccharides have a general formula of Cₓ(H₂O)_{y} where x is usually a large number between 200 and 2500. As the repeating units in the polymer backbone are often six-carbon monosaccharides, the general formula can also be represented as (C₆H₁₀O₅)n where 40≦n≦13000. Cellulose is a polysaccharide consisting of a linear chain of several hundred to over ten thousand β(1→4) linked D-glucose units. Cellulose is insoluble in water and is the most abundant carbohydrate in nature. Cellulose generally has the formula (C₆H₁₀O5)n where n is typically 40-3000. When traditional acid hydrolysis is used for the production of fermentable sugars from cellulose containing materials, the resulting polysaccharide oligomers (i.e., soluble sugars) range from one to seven repeating glucose units. Mechanocatalytic non-aqueous acid hydrolysis performed according to the methods taught herein consistently produces soluble sugars (i.e., a reaction product containing polysaccharide oligomers) having a no greater than two glucose repeating units.

In a more specific embodiment, the soluble sugar content of the reaction products of the non-aqueous acid hydrolysis of the cellulose-containing material is at least 70 percent by weight. In an even more specific embodiment, the soluble sugar content comprises at least 80 percent, at least 85 percent, at least 90 percent, at least 95 percent or 100 percent. In all embodiments, the soluble sugars may comprise at least 70, at least 80, at least 85, at least 90, at least 95, or 100 percent of soluble sugars having no more than two glucose or xylose units. Thus, in view of the teachings herein, those skilled in the art will be able to identify a reaction product produced according to embodiments of the presently disclosed and/or claimed inventive concept(s). Furthermore, the ability to hydrolyze cellulose and/or lignocellulose into soluble sugars provides a material comprising a higher yield of fermentable sugars thereby equating to higher efficiencies and lower cost for producing ethanol and other products from cellulose. As the presently disclosed and/or claimed inventive concept(s) are non-aqueous processes, the complexity of the reactions are decreased and the reaction products do not contain compounds that are detrimental to downstream fermentation and/or other enzymatic, bacterial, or chemical processing.

According to other certain method embodiments, the reaction products possess a specific sugar profile. Thus, according to one embodiment, the presently disclosed and/or claimed inventive concept(s) pertains to a reaction product (typically in the form of a powdered composition, a solid composition, and/or a liquid suspension) comprising three or more of the following: cellobiose, glucose, fructose levoglucosan levoglucosenone, furfural, and 5-hydroxymethylfurural. In another embodiment, the reaction product comprises levoglucosenone or furfural. In an even more specific embodiment, the reaction product comprises levoglucosenone and furfural. Reaction products containing such components or profiles of such components are not produced by acid hydrolysis or enzymatic hydrolysis of cellulose-containing materials. Accordingly, based on this, and in view of the teachings herein, those skilled in the art will be able to identify a reaction product produced according to embodiments of the presently disclosed and/or claimed inventive concept(s).

The resultant reaction products are either directly subjected to fermentation (according to conventional techniques) or are subjected to an intermediate enzymatic hydrolysis step. Alternatively, the reaction products may be stored (either in the powdered, solid, and/or suspension form) until such time that they can be used in a downstream enzymatic, chemical, and/or bacterial process.

### BRIEF DESCRIPTION OF THE DRAWINGS

FIG. 1 is a flow schematic of one embodiment of the non-aqueous solid acid hydrolysis process as disclosed herein.

FIG. 2 is a graphical representation indicating the solubilization efficiency of various solids after three hours of milling in the process as disclosed herein.

FIG. 3 is a graphical representation indicating the effect of milling time on the solubilization of cellulose based upon the use of differing materials as the solid acid catalyst.

FIG. 4 is a graphical representation indicating of the water content of bentonite through the mass loss of bentonite by heating the bentonite material.

FIG. 5 is a graphical representation indicating of the mass loss of cellulose upon heating indicating an adsorbed moisture content of about 4% by weight.

FIG. 6 is a graphical representation indicating differing ratios of cellulose to kaolinite for solubilizing cellulose.

FIG. 7 is a graphical representation indicating differing ratios of cellulose to bentonite for solubilizing cellulose.

FIG. 8 shows the progression of the solubilization of cellulose and reaction product containing soluble sugars produced over time on a thin-layer chromatography

FIG. 9 is a graphical representation indicating the solubilization of cellulose as a function of milling/reaction time.

FIG. 10 is a graphical representation indicating the mechanocatalytic activity of differing solid acid materials.

FIG. 11 is a schematic representation of the depolymerization of cellulose and resulting reaction products.

FIG. 12 is a pictorial representation of the structures of bentonite and kaolinite.

FIG. 13 is a graphical representation of the first and second order plots of the hydrolysis of cellulose.

FIG. 14 is a graphical representation of the change in degree of polymerization of insoluble residues remaining in the reaction products of the hydrolysis of cellulose.

FIG. 15 is a graphical representation indicating that the presently disclosed and/or claimed hydrolysis of cellulose is relatively insensitive to feedstock source of cellulose.

FIG. 16 is a graphical representation indicating the energy consumed in the presently disclosed and/or claimed inventive concept(s).

### DETAILED DESCRIPTION OF THE INVENTIVE CONCEPT(S)

Before explaining at least one embodiment of the presently disclosed and/or claimed inventive concept(s) in detail, it is to be understood that the presently disclosed and/or claimed inventive concept(s) is not limited in its application to the details of construction and the arrangement of the components or steps or methodologies set forth in the following description or illustrated in the drawings. The presently disclosed and/or claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and/or claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which this presently disclosed and/or claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed herein can be made and executed without undue experimentation in light of the present disclosure. While the articles and methods of the presently disclosed and/or claimed inventive concept(s) have been described in terms of preferred embodiments, it will be apparent to those of skill in the art that variations may be applied to the articles and/or methods and in the steps or in the sequence of steps of the method described herein without departing from the concept, spirit and scope of the presently disclosed and/or claimed inventive concept(s). All such similar substitutes and modifications apparent to those skilled in the art are deemed to be within the spirit, scope and concept of the presently disclosed and/or claimed inventive concept(s).

As utilized in accordance with the present disclosure, the following terms, unless otherwise indicated, shall be understood to have the following meanings.

The use of the word “a” or “an” when used in conjunction with the term “comprising” in may mean “one,” but it is also consistent with the meaning of “one or more,” “at least one,” and “one or more than one.” The use of the term “or” is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. The use of ordinal number terminology (i.e., “first”, “second”, “third”, “fourth”, etc.) is solely for the purpose of differentiating between two or more items and is not meant to imply any sequence or order or importance to one item over another or any order of addition, for example.

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC and, if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

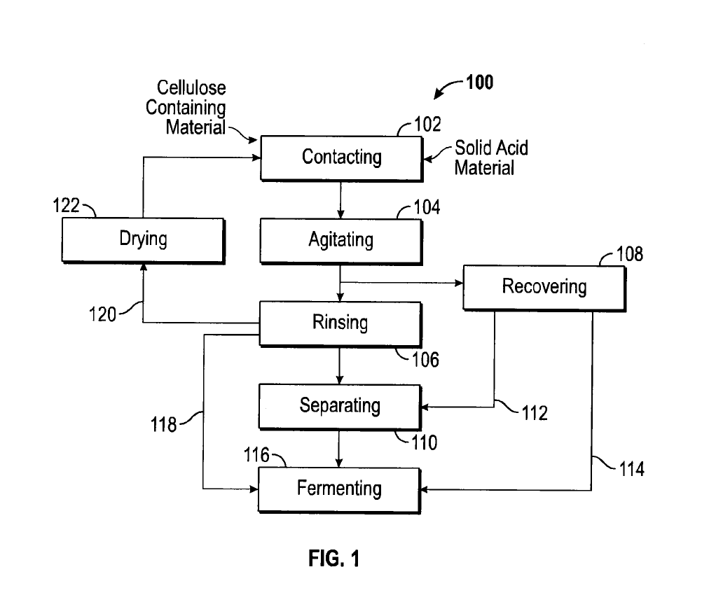

Now referring to the figures, FIG. 1 shows a schematic representation of a process 100 for the production of soluble and fermentable sugars from a cellulose-containing material in accordance with one aspect of the presently disclosed and/or claimed inventive concept(s). The process 100 comprises the hydrolytic conversion of a cellulose-containing material to a reaction product(s) comprising soluble sugars. The process 100 is a non-aqueous solid acid hydrolysis reaction. In step 102, a quantity of a cellulose-containing material is contacted with a quantity of a solid acid material. To accomplish this, the materials may be introduced into any suitable vessel and, preferably, the vessel in which the step of agitating will take place in step 104, for example, by any suitable method, and simultaneously or sequentially one after the other. While not necessary, it is contemplated that the cellulose-containing material may be pretreated as desired, such as by breaking or grinding the material down to a desired size, before bringing the cellulose-containing material and solid acid material into contact with one another. In all embodiments, the aggregation of the cellulose-containing material and the solid acid material results in a non-aqueous reactant mixture suitable for a non-aqueous acid hydrolysis reaction.

The cellulose-containing material may be any material or mixture of materials having a cellulose content. Thus, in one embodiment, the cellulose-containing material may be a purified source of cellulose and, may in certain embodiments, comprise greater than 20, 30, 40, 50, 60, 70, 80, 90, 95, or even 100 percent pure cellulose separated away from any contaminants and/or other reactive and non-reactive materials. In another embodiment, the cellulose-containing material is a natural cellulosic feedstock, typically referred to as a “biomass.” Exemplary biomass materials include wood, paper, switchgrass, wheat straw, agricultural plants, trees, agricultural residues, herbaceous crops, starches, corn stover, saw dust, and high cellulose municipal and industrial solid wastes. The nature of the cellulose-containing material should not be considered to be constraining to the processes and methods disclosed herein. Indeed, the inventors have found to date that all cellulose-containing materials that have been tested are suitable and appropriate for the processes and methods disclosed herein.

In one embodiment, the biomass material is a lignocellulosic material having a cellulose, hemicellulose, and lignin content. Typically, in such a lignocellulosic material, the cellulose, hemicellulose, and lignin are bound together in a complex gel structure along with small quantities of extractives, pectins, protein, and ash. As discussed above, generally, lignocellulosic material is poorly accessible to microorganisms, yeast, and enzymes, and the like that are sometimes used to hydrolyze cellulose. A substantial benefit of the presently disclosed and/or claimed inventive concept(s) is that when the cellulose-containing material is a lignocellulosic material, the lignin and hemicellulose can also react with the solid acid material and thereby provide additional useful reaction products, thereby eliminating a significant portion of the waste component from the process and eliminating the need to purify the cellulose material before hydrolyzing the cellulose-containing material with the solid acid material. Any quantity of cellulose-containing material may be provided and used in the presently disclosed and/or claimed inventive concept(s) and the particular ratios of reactants disclosed herein should be considered as not-limiting examples and/or specific embodiments.

The solid acid material may be any solid material having a surface acidity. By “solid,” it is meant a solid material, a semi-solid material, or any other material having a water content of less than about 40% by weight. Surface acidity refers to the acidity of the solid surface of the material. Surface acidity determination methods are founded on the adsorption of a base from the base's solution. The amount of base that will cover the solid surface of the solid acid material with a monolayer is defined as the surface acidity and corresponds to the pKₐ of the base used. The base used may be n-butylamine, cyclohexamine, or any other suitable base. The degree of surface acidity is typically expressed by the Hammet and Deyrups H₀ function.

H₀=pK_{BH+}−log(C_{BH+}/C_{B}) (I)

Thus, according to equation I, when an indicator, B, is adsorbed on an acid site of the solid surface of the material, a part of the indicator is protonated on the acid site. The strength of the acid sites may be represented by equation (I) by the value of pK_{BH+} of BH⁺. BH⁺ is the conjugate acid of indicator B when the concentration of BH⁺(C_{BH+}) is equal to the concentration of B (C_{B}). Therefore, the acid strength indicated by H₀ shows the ability of the conjugate to change into the conjugate acid by the acid sites that protonates half of the base indicator B. Under a Lewis definition, the H₀ value shows the ability that the electron pair can be received from half of the absorbed base indicator B. See, Masuda et al., Powder Technology Handbook, 3^{rd} Ed. (2006). A H₀ of −8.2 corresponds to an acidity of 90% sulfuric acid and a H₀ of −3.0 corresponds to an acidity of about 48% sulfuric acid.

Any suitable method of determining the H₀ of the solid acid material may be used, such as the method using the adsorption of n-butylamine from its solution in cyclohexane as set forth in Investigation of the Surface Acidity of a Bentonite modified by Acid Activation and Thermal Treatment, Turk. J. Chem., 2003; 27:675-681. Alternatively, indicators, generally referred to as Hammett indicators, may be used to determine the H₀ of a material. Hammett indicators rely on color changes that represent a particular surface acidity of the subject material. In the presently disclosed and/or claimed inventive concept(s), any solid acid material having a surface acidity can be used although a number of solid acid materials have been found to be particularly beneficial. For example, it has been found that a solid acid material having an H₀ of less than about −3.0, and preferably less than about −5.6 is particularly useful in the processes and methods disclosed herein.

In one embodiment, the solid acid material is a clay material. As used herein, “a clay material” is defined as a material composed primarily of fine-grained minerals, which is generally plastic at appropriate water contents and will harden when dried or fired in, for example, a kiln. Exemplary minerals that comprise the major proportion of clay materials for use in the presently disclosed and/or claimed inventive concept(s) include kaolinite, halloysite, attapulgite, montmoirllonite, illite, nacrite, dickite, and anauxite. Non-limiting examples of clays for use in the presently disclosed and/or claimed inventive concept(s) include fuller's earth, kaolin, and bentonite. Kaolin is a clay material that mainly consists of the mineral kaolinite. Bentonite is a clay containing appreciable amounts of montmorillonite, and typically having some magnesium associated therewith. Fuller's earth usually has a high magnesium oxide content in combination with montmorillonite or palygorskite (attapulgite) or a mixture of the two; additional minerals that may be present in fuller's earth deposits are calcite, dolomite, and quartz. Optionally, the clay material may be acid-treated to provide further surface acidity to the clay material in addition to its inherent acidic properties. Alternatively, the clay material may be treated with a base or other agent to lower the surface acidity of the clay material. It should be understood that the surface acidity can be tailored to meet specific needs or embodiments of the presently disclosed and/or inventive concepts and such tailoring is well within the abilities of a skilled artisan.

In another embodiment, the solid acid material is any aluminosilicate or hydrated aluminosilicate mineral. For example, the solid acid may be vermiculite, muscovite mica, kaolinite, halloysite, attapulgite, montmorillonite, illite, nacrite, dickite, and anauxite, or zeolites such as analcime, chabazite, heulandite, natrolite, phillipsite, and stilbite, or any mineral having the general formula Al₂O₃.xSiO₂.nH₂O.

In another embodiment, the solid acid material is a superacid material. Superacid materials are useful in the presently disclosed and/or claimed inventive concept(s) because of the high number of acidic sites on the surface of the superacid material. Brönsted superacids may be described as acids which are stronger than 100% sulfuric acid. Lewis superacids may be described as acids that are stronger than anhydrous aluminum trichloride. Solid superacids are composed of solid media, i.e., alumina, treated with either Brönsted or Lewis acids. The solids used may include natural clays and minerals, metal oxides and sulfides, metal salts, and mixed metal oxides. Exemplary Brönsted superacids include titanium dioxide:sulfuric acid (TiO₂:H₂SO₄) and zirconium dioxide:sulfuric acid (ZrO₂:H₂SO₄) mixtures. Exemplary Lewis superacids involve the incorporation of antimony pentafluoride into metal oxides, such as silicon dioxide (SbF₅:SiO₂), aluminum oxide (SbF₅:Al₂O₃), or titanium dioxide (SbF₅:TiO2). In one embodiment, the superacid is a metal oxide treated with either Brönsted or Lewis acids. In a particular embodiment, the superacid is alumina treated with sulfuric acid as set forth below. Alternatively, the solid acid material may be a silicate material, such as talc or any other suitable solid material having a surface acidity, such as alumina, and combinations of any of the materials described herein.

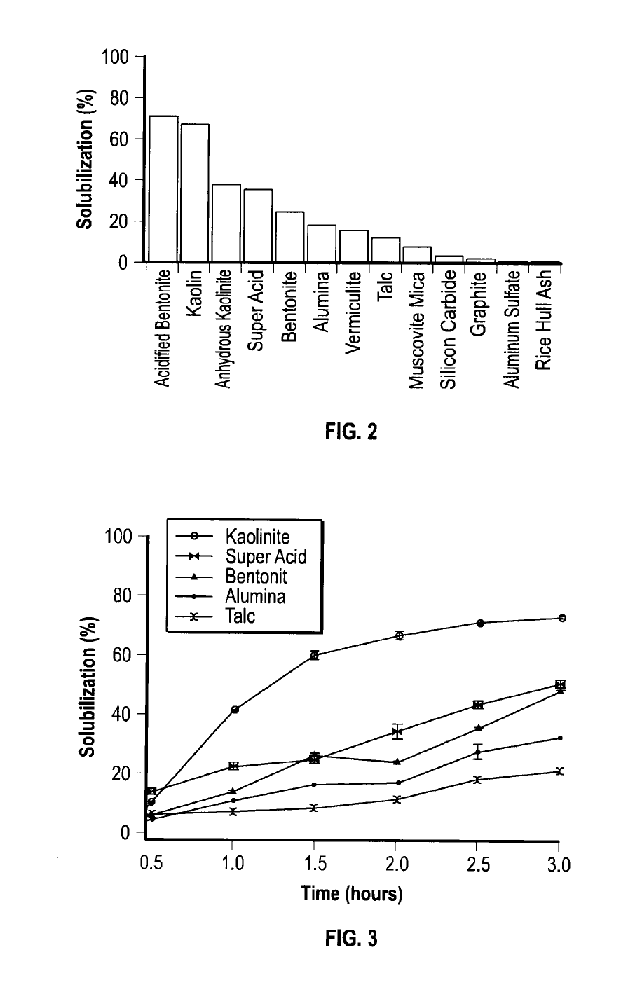

As shown in FIG. 2, the solubilization efficiency for a number of materials was compared for the solubilization of cellulose after three hours of milling in a SPEX 8000D mixer mill (SPEX CertiPrep, Metuchen, N.J.). As shown, solid acid materials having a surface acidity value (H₀) of less than about −3.0 were particularly effective at solubilizing cellulose. For example, acidified bentonite, kaolin, anhydrous kaolinite, a super acid in the form of aluminum oxide treated with sulfuric acid, all have H₀ values of less than about −3.0. Acidified bentonite and kaolin provided the best solubilization efficiencies, followed by anhydrous kaolinite, a super acid in the form of aluminum oxide treated with sulfuric acid, bentonite, alumina, vermiculite, muscovite mica, talc, silicon carbide, graphite, aluminum sulfate, and rice hull ash. Silicon carbide, graphite, aluminum sulfate, and rice hull ash are known not to have any appreciable surface acidity and did not show any appreciable solubilization of cellulose according to the presently disclosed and/or claimed inventive concept(s).

Since kaolin provided a high degree of solubilization of cellulose, specifically, a solublization efficiency for cellulose of at least about 70%, in one embodiment, in one particular embodiment it is contemplated that the solid acid material is kaolin. Kaolin is composed primarily of the mineral kaolinite (Al₂Si₂O₅(OH)₄) which is a layered silicate made of alternating sheets of octahedrally coordinated aluminum and tetrahedrally coordinated silicon that are bonded by hydroxyl groups. Alternatively, the solid acid material may be in the form of anhydrous kaolin, which may be prepared by heating kaolin at about 800° C. for at least about 6 hours and preferably at about 800° C. for about 8 hours.

In another embodiment, the solid acid material is bentonite, and preferably acidified bentonite. Bentonite is an absorbent aluminum phyllosilicate clay material consisting mostly of montmorillonite, (Na, Ca)_{0.33}(Al,Mg)₂Si₄O₁₀(OH)₂.(H2O)ₙ. Two types of bentonite exist: swelling bentonite which is also called sodium bentonite and non-swelling bentonite or calcium bentonite. Preferably for use with the presently disclosed and/or claimed inventive concept(s), the solid acid material comprising bentonite is non-swelling bentonite. If an acidified bentonite is chosen as the solid acid material, it may be prepared, for example but not by way of limitation, by treating bentonite with one or more acids. Particularly, bentonite may be treated with a 1 M hydrochloric acid solution thereby providing an acidified bentonite material for use as the solid acid material. In still another particular embodiment, the solid acid material may be a solid superacid comprising alumina treated with 2 M sulfuric acid, filtered and calcined at about 800° C. for about 5 hours.

Without wishing to be bound by any particular method of reaction, it is believed that the kaolin and acidified bentonite are particularly useful as the solid acid material for use in the presently disclosed and/or claimed inventive concept(s) because they provide a high surface acidity along with an inherent amount of water with the material. Such water is a function of the materials' inherent water of crystallization and a free water content. Such an inherent water content useful and necessary to hydrolyze the glycosidic bonds of the cellulose-containing material in the solid acid hydrolysis process presently disclosed and/or claimed herein. Although the solid acid material has an inherent water content, it should be understood that the reactants—either alone or in combination—are still to be considered in a solid or non-aqueous phase. Therefore, using acidified bentonite, bentonite, and/or kaolin as the solid acid material, a non-aqueous solid acid hydrolysis of a cellulose-containing material can be performed—i.e., a hydrolysis reaction can take in a non-aqueous environment thereby providing a substantial benefit. Additional water is not required for the hydrolysis reaction to be completed and the time and expense of hydrolyzing the cellulose-containing material and extracting and/or separating the reaction products from unreacted materials downstream of the reactor.

Kaolin and bentonite generally have a free water content of greater than about 4% by weight, as well as a water of crystallization content. Accordingly, in one embodiment, the free water content of the solid acid material is from about 4% to about 10% by weight. Water of crystallization refers to water that occurs as a constituent of crystalline substances in a definite stoichiometric ratio. This water can be removed from the substances by the application of heat at about 700° C., for example, but not by way of limitation, and its loss usually results in a change in the crystalline structure. In the presently disclosed and/or claimed inventive concept(s), it is believed that the agitating step 104 (as described herein) provides the localized heat necessary to remove the water, including the water of crystallization, from the solid acid material (when water of crystallization is present) and thereby provide any water required for the hydrolysis of the cellulose-containing material. As such, the solid acid material is, in effect, providing both the catalytic acid functionality as well as at least a portion of the water required for the hydrolysis reaction of the cellulose-containing material to take place.

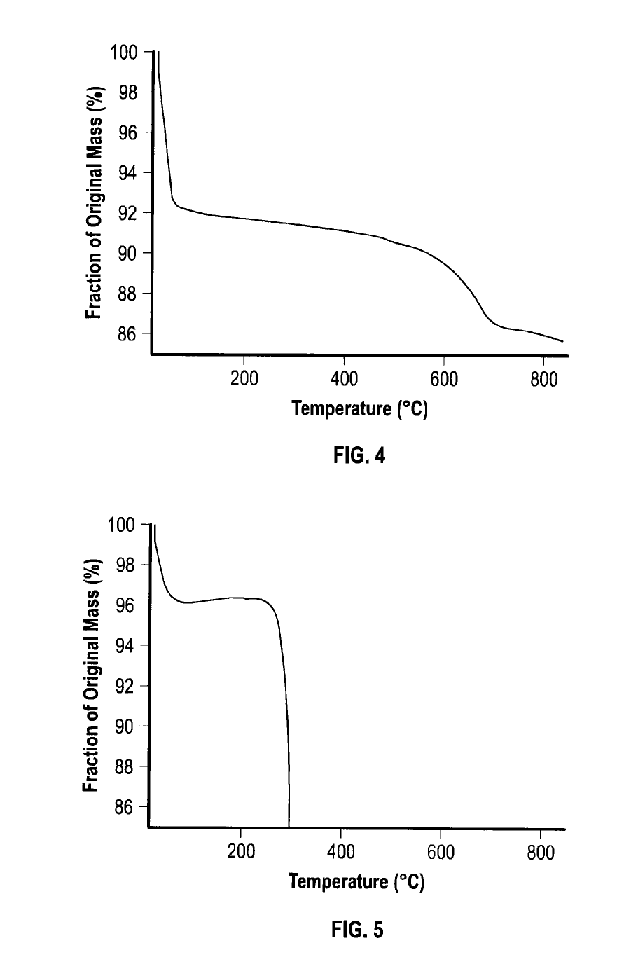

The water content of most compounds, including the water of crystallization of the solid acid material, can be determined by thermogravimetric analysis (TGA), where the sample is heated, and the accurate weight of a sample is plotted against the temperature. Alternatively, any other suitable method for determining water content of the solid acid material may also be used, including mass loss on heating, Karl Fischer filtration, and freeze drying, or any other suitable method. As such, one of ordinary skill in the art would be readily capable of determining if a particular solid acid material had a water content of from about 4% to about 10% as disclosed in one particular embodiment of the presently disclosed and/or claimed inventive concept(s). For example, and as shown in FIG. 4, heating 5 milligrams of bentonite to a temperature of 850° C. at a rate of 10° C./minute indicates a water loss of from about 7.0 to about 7.5% by mass at 100° C. for adsorbed water and an additional mass loss of another about 5% to about 6% by mass due to the water of crystallization. It is believed that kaolin has a similar free water content relative to bentonite and would exhibit similar mass loss corresponding to the adsorbed water and/or the water of crystallization being removed. As discussed above, the inherent water of crystallization and free water content of the solid acid material and, in particular embodiments, the clay materials disclosed herein, is useful for the hydrolysis of the cellulosic glycosidic bond in the processes of the presently disclosed and/or claimed inventive concept(s).

In another embodiment, the solid acid material is an acid-treated material, such as sulfuric acid-treated alumina to form a superacid. To prepare this superacid, alumina was stirred in 2 M sulfuric acid, filtered and calcined at about 800° C. for about 5 hours. Treating the alumina with sulfuric acid adds sulfate ions to the solid alumina surface, thereby allowing the solid acid material to further accept electrons. As a result, these superacids have a very high surface acidity. However, while superacids may have a higher surface acidity than bentonite or kaolinite, the superacids may not have as inherent water as the bentonite and/or kaolinite solid acid materials. As a result, while not wishing to be bound by theory, it appears that the additional water content found in kaolin and bentonite contributes to a higher solubilization efficiency for cellulose within a cellulose-containing material when reacted with a solid acid material in a non-aqueous environment. This statement is further supported in showing that the solubilization efficiency is lower for anhydrous kaolinite which has a lower inherent water content than kaolin.

The ratio of the cellulose-containing material to the solid acid material is such that the solubilization of cellulose is optimized. Generally, the solubilization efficiency is optimized by determining a ratio of the cellulose-containing material to the solid acid material, wherein a surface interaction of the solid acid material and the cellulose-containing material is maximized and the combined inherent water content of the cellulose-containing material and solid acid material is optimized. If there is too much moisture in the combined cellulose-containing material and the solid acid material, or in the individual materials themselves, during the agitating step 104, the amount of kinetic energy available to drive the hydrolysis of cellulose is lowered and the overall process results in a lowered yield of reaction products—i.e., solid and/or powdered soluble and fermentable sugars. On the other hand, incomplete solubilization of the cellulose results if the water content is too low. As such, it should be appreciated to a skilled artisan that there must exist at least some inherent water content in the cellulose-containing material and the solid acid material, alone or in combination, in order for the hydrolysis reaction to occur. It should be understood, however, that the existence of such an amount of inherent water in the reactants should not be interpreted to mean that the reaction (i.e., the agitating step 104) occurs in an aqueous environment: rather, while requiring some minor amount of water, the hydrolysis reaction is being carried out in a non-aqueous environment and the cellulose-containing material and the solid acid material should be considered to be in a solid form.

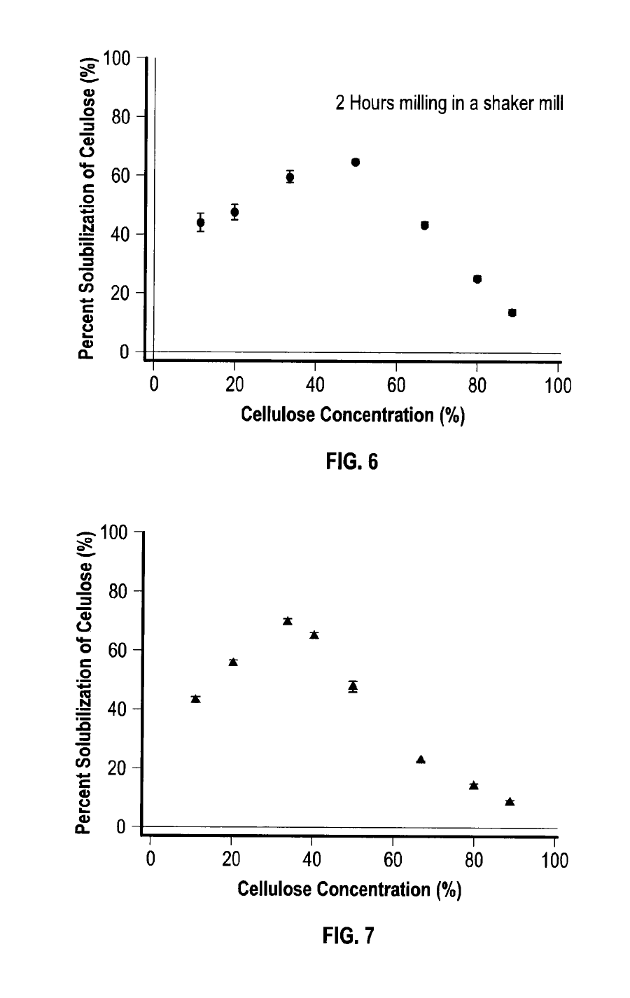

In one embodiment, the cellulose-containing material is provided in a ratio of from about 0.5:1 to about 10:1 cellulose-containing material to solid acid material. In a particular embodiment, when the solid acid material is kaolin for example, FIG. 6 indicates that at least one optimal yield of reaction product containing solid and/or powdered soluble and fermentable sugars is obtained with about a 1:1 mass ratio of cellulose to kaolin after about 2 hours of milling in a SPEX 8000D shaker mill (SPEX CertiPrep, Metuchen, N.J.). The reactants were milled in 0.5 hour increments in 50 mL milling vials constructed of 440C stainless steel with three 440C steel balls ½″ in diameter being used as a milling media. Similarly, FIG. 7 that at least one optimal yield of reaction product containing solid and/or powdered soluble and fermentable sugars is obtained with a 1:2 mass ratio of cellulose to bentonite after two hours of milling in a SPEX 8000D shaker mill (SPEX CertiPrep, Metuchen, N.J.). The reactants were milled in 0.5 hour increments in 50 mL milling vials constructed of 440C stainless steel with three 440C steel balls ½″ in diameter being used as a milling media. As used herein, the term “milling” should be understood to be the agitating step 104 wherein the reactants (i.e, the cellulose-containing material and the solid acid material) are brought into contact with one another as well as with the milling media within the shaker mills. During the agitation step 104, the reactants hydrolytically react to form the reaction product containing solid and/or powdered soluble and fermentable sugars. Once again, the reactants and the milling media are being agitated in step 104 in a non-aqueous environment and both the reactants and the reaction product should be considered as being in a solid form.

In one embodiment, the cellulose-containing material has a free water content of from about 4% to about 40% of the cellulose-containing material. As shown in FIG. 5, by heating 3.5 milligrams of 100% pure cellulose (Avicell™ microcrystalline cellulose, Fisher Scientific) to a temperature of about 850° C. at a rate of about 10° C./min, the mass loss indicated to occur at about 100° C. demonstrates that the Avicell™ microcrystalline cellulose had an adsorbed moisture content of about 4%. From known assumptions and calculations, in order to convert 100% cellulose to 100% fructose or glucose, the minimum water required is 4.76% by weight. Thus, when the cellulose-containing material and the solid acid material are contacted in step 102 and agitated in step 104, in one specific non-limiting embodiment, the free water content of the collective mixture of the reactants (i.e., the inherent water of the solid acid material and the cellulose and/or cellulose-containing material) should be less than about 45% by weight of the materials (thereby maintaining the reactants in a solid and/or non-aqueous environment), and, more preferably, the free water content of the collective mixture of the reactants is less than about 30% by weight, less than about 20% by weight, less than about 10% by weight, and from about 4 to about 8% by weight. In all embodiments, the free water content of the collective mixture of the reactants is from about 4% to about 40% and, more particularly, from about 8% to about 40% by weight. As described, a sufficient water content is provided by the solid reactants in the non-aqueous environment to hydrolyze the cellulose (separately or as part of the cellulose-containing material) to a reaction product containing solid and/or powdered soluble and fermentable sugars. It is also contemplated that the process 100 be performed at ambient temperature (although, the term “ambient” should be understood as I the purposeful absence of heating or cooling—it is contemplated that the reactants and reaction mixture may autogenously provide additional heat through exothermic reactions). Additionally, it is contemplated that the process 100 be performed without the addition of water to the reactant mixture. Of course, although the process is disclosed and described as occurring in a non-aqueous environment, the water content of the reactant mixture may be up to about 40% by weight and yet still be considered as comprising a non-aqueous mixture. As such, it may be desirable in some situations to add some amount of water to the reactant mixture—e.g., if the reactants have a combined free water content less than or about 4% or if any particular reactant mixture of cellulose-containing material and solid acid material requires a greater amount of water than is inherently in the mixture due to the reactants themselves. It should be considered, however, that a significant advantage of the process 100 is that no additional water is generally required for the solid acid material to hydrolytically catalyze the cellulose-containing material into a reaction product containing solid and/or powdered soluble and fermentable sugars. As would be readily apparent to one of ordinary skill, the ability to perform the process 100 according to the presently disclosed and/or claimed inventive concept(s) provides an efficient and effective means of producing a reaction product containing solid and/or powdered soluble and fermentable sugars on a large commercial batch or continuous manufacturing scale.

In step 104, the cellulose-containing material and the solid acid material are agitated for a time sufficient to provide a reaction product containing solid and/or powdered soluble and fermentable sugars. The agitation may take place in any suitable vessel or reactor. In one embodiment, the agitating step 104 takes place in a ball, roller, jar, hammer, or shaker mill. The mills generally grind samples by placing them in a housing along with one or more grinding elements and imparting motion to the housing. The housing is typically cylindrical in shape and the grinding elements and/or milling media (as discussed above) are typically steel balls, but may also be rods, cylinders, or other shapes. Generally, the containers and grinding elements are made from the same material.

As the container is rolled, swung, vibrated, or shaken, the inertia of the grinding elements and/or milling media causes the milling media to move independently into each other and against the container wall, grinding the cellulose-containing material and the solid acid material and bring the reactants into reactive contact with one another. In one embodiment, the mill is a shaker mill using steel balls as the milling media and shaking to agitate the cellulose-containing material and the solid acid material. The mills for use in the presently disclosed and/or claimed inventive concept(s) may range from those having a sample capacity of a gram or less to large industrial mills with a throughput of tons per minute. Such mills are available from SPEX CertiPrep of Metuchen, N.J., for example, Paul 0. Abbe, Bensenville, Ill., or Union Process Inc., Akron, Ohio. For some mills, such as a steel ball mill from Paul O. Abbe, the optimal fill volume is about 25% of the total volume of the mill. The number of steel balls (i.e., the milling media) required for the process 100 is typically dependent upon the amount of kinetic energy available. High energy milling like that in a shaker mill will require less milling media than lower energy milling methods such as rolling mills. For shaking mills, a ball to sample mass ratio (i.e., a milling media to reactant mass ratio) of about 12:1 is sufficient. For rolling mills, a ball to sample mass ratio (i.e., a milling media to reactant mass ratio) of about 50:1 works well for a rolling rate of about 100 rpm. Lower mass ratios can be obtained by increasing the amount of kinetic energy available to the system. In a roller mill, this can be achieved through the optimization of mill geometry and/or increasing the mill's rotational velocity.

A significant advantage of the presently disclosed and/or claimed inventive concept(s) is that the processes described herein can be performed at ambient temperature without the need for added heat, cooling, or modifying pressure. Instead, the processes, including the agitation step, can be performed under ambient conditions. Without wishing to be bound by theory, it is believed the agitating step 104 of the cellulose-containing material with the solid acid material, such as in with the aforementioned mills, provides the process with the energy required for the hydrolysis of the cellulose in the cellulose-containing material. Additionally, it is believed that the energy required for the hydrolysis of all compounds within a lignocellulosic material (i.e., cellulose, hemicellulose and lignin) is provided by the agitating step 104 according to the processes of the presently disclosed and/or claimed inventive concept(s). Moreover, it is believed the agitating step 104 also allows more of the cellulose-containing material to contact the acidic sites on the surface of the solid acid material. Even further, it is believed that the heat created by the agitating step 104 frees the inherent water content of the reactants to provide the water necessary for the hydrolysis reaction to take place. In an alternate embodiment, the agitating step 104 may occur at a controlled temperature of between about −5 to about 105 degrees C. It is contemplated that the agitating step 104 may occur at any temperature degree value within this range (rounded to the nearest 0.5 centigrade unit), or within any sub-ranges within this range (rounded to the nearest 0.5 centigrade unit).

After the step of agitating 104, the reaction products may be optionally washed with a first aqueous solution and resulting solubilized reaction products can be recovered in step 108. Typically, this aqueous solution will comprise an aqueous solution of reaction product containing solid and/or powdered soluble and fermentable sugars, typically in the form of monosaccharides, disaccharides, and polysaccharides. When the cellulose-containing material is a lignocellulosic material, this aqueous solution may also comprise further soluble sugars, as well as useful aromatic hydrocarbons, such as vanillin. Vanillin is a known flavoring additive in the food industry. It is contemplated that the first aqueous solution may also comprise other byproducts of the decomposition reactions which occur during the agitating step 104, such as hydroxymethylfurfural or HMF. Hydroxymethylfurfural is an aldehydic compound that is found in a number of foods, such as milk, fruit juices, spirits, and honey. Thus, in one embodiment, the processes as described herein can also be used for the production of furfurals for example, but not by way of limitation, HMF and vanillin. For example, glucose produced by the hydrolysis of cellulose can be used as a starting material to produce furfurals by dehydration of the glucose compounds. The production of HMF may be enhanced by the use of solid acids that incorporate transition metals such as, but not limited to, chromium and molybdenum.

Preferably, after the step of agitating 104, the cellulose-containing material and solid acid material may be separately rinsed with a second aqueous solution as set forth below in step 106. Alternatively, from recovering step 108, at least a portion of the first aqueous solution is optionally directed to a separating step 110 as indicated by arrow 112, where any separation of the components of the first aqueous solution can be performed by any suitable technique known in the art. For example, if vanillin is desired to be separated out from the first aqueous solution, the vanillin can be removed by any suitable method, such as by chromatographic methods well known in the art. Further alternatively, at least a portion of the first aqueous solution may be directed to fermenting step 116 as described below and indicated by arrow 114.

When using a mill as described herein, the hydrolysis processes described herein are generally carried out as a batch process. In addition, the vessel where the agitating and hydrolysis reaction takes place may be performed in a continuous attritter, which is commercially available from Union Process, Akron, Ohio. This device more generally allows the process to be carried out as a continuous process.

The milling time performed in the agitating step 104 may have an effect on the extent of solubilization of the cellulose-containing material. For example, as shown in FIG. 3, kaolin approaches a maximum percent of solubilization after about two hours of shaker milling in a sealed hardened steel vial with a ball to sample mass ratio (i.e., milling media to reactant mixture mass ratio) of 12:1. As is also shown in FIG. 3, when sulfuric acid-treated alumina, bentonite, alumina, and talc are used as the solid acid material, it does not appear that a maximum solubilization does not occur even after three hours of shaker milling in a sealed hardened steel vial with a ball to sample mass ratio (i.e., a milling media to reactant mixture mass ratio) of 12:1.

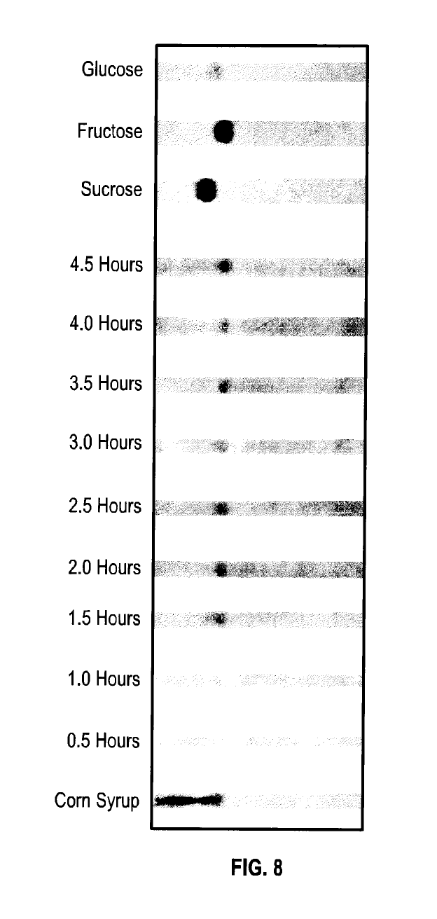

As shown in FIG. 8, 1 gram of cellulose and 1 gram of kaolin were milled in hardened steel vials with 0.5″ steel balls (i.e., milling media) and a ball to sample mass ratio (i.e., milling media to reactant mixture mass ratio) of 12:1. The agitation was supplied by a SPEX 8000D mixer mill (SPEX CertiPrep, Metuchen, N.J.). The production of reaction product containing solid and/or powdered soluble and fermentable sugars was monitored over a time period of 4.5 hours by thin-layer chromatography using an EMD Chemicals cellulose TLC plate, 20 cm×10 cm. A developing solution was used that consisted of a mixture of butanol, water, and acetic acid. The oligosaccharides found in the reaction product containing solid and/or powdered soluble and fermentable sugars were stained by spraying with a urea-phosphoric acid solution and heating to about 80° C. for about 10 minutes. This stain colors ketoses blue and aldoses a pale red. Individual samples were prepared by milling samples (i.e., agitating according to step 104 the reactants) having a total mass of 2 grams for the prescribed amount of time in ½ hour increments.

As can be seen by FIG. 8, a notable amount of the reaction product containing solid and/or powdered soluble and fermentable sugars increasingly becomes fructose during the reaction, in addition to glucose. In addition, the agitating step 104 may produce a further quantity of soluble sugars, including sugars in the form of monosaccharides, disaccharides and polysaccharides. For example, the solubilized sugars may be polysaccharides up to eight glucose units. In addition, other byproducts may be formed in the agitating step 104, such as furfurals from the dehydration of glucose and small quantities of ethanol. If ethanol is formed, the ethanol may be removed from the mill by any suitable method, such as by vacuum distillation, as the ethanol is formed. If the cellulose-containing material is a hemicellulose material, the agitating step 104 may also produce further soluble sugars or long-chain sugars, as well as aromatic hydrocarbons and furfurals, such as HMF. The majority of soluble sugars produced by the processes described herein are suitable for use in fermenting processes to produce ethanol. As such, the reaction product containing solid and/or powdered soluble and fermentable sugars removed from the mill after the agitating step 104 may contain a variety of different types of soluble and fermentable sugars and/or other aromatic compounds.

It is contemplated that at least about 80% of the cellulose in the cellulose-containing material may be solubilized to reaction product containing solid and/or powdered soluble and fermentable sugars in various embodiments of the present invention. It is appreciated that higher efficiencies may be obtained by selecting the various solid acids, milling time, and modifying the ratio of the cellulose-containing material to the solid acid material. If relatively pure cellulose is used, it is contemplated that less cellulose-containing material may be required than if the cellulose-containing material were a biomass material, such as lignocellulose.

Referring again to FIG. 1, after step 104 of agitating, the cellulose-containing material and solid acid material may be washed with a second aqueous solution in step 106 to produce a second aqueous solution comprising reaction product containing solid and/or powdered soluble and fermentable sugars. The sugars may be in the form of monosaccharides, disaccharides and polysaccharides. Any suitable method of determining the amount of solubilized sugars may be used, such as by chromatographic methods well known in the art. Moreover, the presence of particular solubilized sugars may be confirmed by any suitable chromatography method, such as thin-layer chromatograph, gas chromatography (GC), high-pressure liquid chromatography (HPLC), GC-MS, LC-MS, or any other suitable method known in the art. The second aqueous solution may also comprise furfurals, ethanol, aromatic hydrocarbons, such as vanillin as previously described herein.

The washing step 106 may be repeated until it is relatively certain that the bulk of the reaction product containing solid and/or powdered soluble and fermentable sugars has been recovered in the second aqueous solution. Thereafter, the second aqueous solution may be directed to fermenting step 116 as indicated by arrow 118 or alternatively to separating step 110 for separation of any of the desired components by any suitable technique known in the art.

Since the solid acid material is acting as a catalyst in the hydrolysis of the cellulose-containing material, the solid acid material may be recycled. Thus, optionally, the solid acid material may be directed to drying step 122 to dry the material to a suitable moisture content, if necessary, as shown by arrow 120 and a new quantity of cellulose-containing material can be combined with all or a portion of the recycled solid acid material to again produce a quantity of solubilized sugars. If no drying step is necessary, the rinsed solid acid material can be immediately reused in contacting step 102. In either instance, the rinsed solid acid material is optionally recycled and reused to hydrolyze further cellulose-containing material by starting the process again at step 102. Additional solid acid material may be added as needed to supplement the recycled solid acid material when redoing step 102. Accordingly, a significant advantage of the presently disclosed and/or claimed inventive concept(s) is that at least a portion of the solid acid material may be reused continuously, thereby saving considerable material and expense.

The recovered fermentable sugars from step 108, any portion of the first and/or second aqueous solutions, or all of the first and/or second aqueous solutions having the soluble, and mainly fermentable sugars, may then be fermented by any suitable method, to produce ethanol as indicated by step 116 of FIG. 1. For example, yeast, genetically engineered strains of E. coli, or other commercially available products may be used to convert the sugars to ethanol. Initially, the soluble sugars may be converted to a more desirable sugar by enzymes.

Alternatively, the soluble sugars may be directed to a process for carmelization of the soluble sugars, such as sucrose and glucose. Carmelization provides desirable color and flavor in bakery goods, coffee, beverages, beer and peanuts. Specifically, the carmelization process can produce useful compounds, such as furans like hydroxymethylfurfural (HMF) and hydroxyacetylfuran (HAF), furanones such as hydroxydimethylfuranone (HDF), dihydroxydimethylfuranone (DDF) and maltol from disaccharides and hydroxymaltol from monosaccharides. Hydroxymethylfurfural (HMF) is found in honey, juices, milk but also in cigarettes. Thus, as well as producing a feedstock for the production of ethanol, the present invention may also provide a feedstock for the production of valuable food component, such as hydroxymethylfurfural.

### EXAMPLES

Pure microcrystalline cellulose (Avicel™, Brinkmann) was utilized to investigate the performance of different solid catalysts. The natural cellulose sources Z. mays indurate (flint corn), Prunus stone, paper, aspen wood, and mixed biomass were collected from local sources. The grasses: A. gerardii (Big Bluestem), S. scoparium (Little Bluestem) and P. virgatum (Switchgrass) were supplied by Agricol Corporation (Madison, Wis.). All natural cellulose sources were dried at room temperature to a moisture content of <10% and cut to 2 cm or smaller pieces.

The materials kaolinite (Edgar Plastic Kaolin, Axner Pottery Supply, Oviedo, Fla.), delaminated kaolinite (Kaopaque 10™, IMERYS), aluminium phosphate (Fisher Scientific), aluminium oxide (LT. Baker), talc (Nytol 100HR™, Axner Pottery Supply), Y-type zeolite (HS-320, Hydrogen Y, Wako Chemicals), bentonite (Asbury Carbons), vermiculite, quartz, muscovite mica, silicon carbide (−325 mesh, Electronic Space Products International), graphite (grade TC306, Asbury Carbons), and aluminium sulfate (Fisher Scientific) were used as received. Layered silicates were H+ exchanged by soaking in 1 M hydrochloric acid for 12 h, filtering and dried at 80.0 overnight. Chemically delaminated kaolinite was prepared by intercalating with urea and deintercalating by washing with water. The super acid was prepared by stirring aluminium oxide (J. T. Baker) in 2.5 M H₂SO₄ followed by calcination at 600° C.

(i) Mechanical Processing

Various amounts of cellulose and catalyst were ground using a rolling mill (custom), mixer mill (SPEX Certiprep™, Metuchen, N.J.), or attrition mill (Union Process Inc., Akron Ohio). Initial catalyst assessment was performed using a mixer mill. Typically, 2 grams of a 1:1 mixture of catalyst (i.e., the solid acid material described above) and cellulose were ground in a 65 mL vial (1.5″ ID×2.25″ deep) made of 440C steel, utilizing three 0.5″ balls (i.e., the milling media described above) made of the same material as the milling vial. Attrition milling experiments were performed by Union Process, Inc. in a 1-SD attrition mill run at 350 rpm with a 1.5 gallon tank, 40 lbs of 0.25″ chrome steel (SAE 52100) balls as the milling media, and 1200 g of a 1:1 mixture of cellulose and catalyst. Rolling mill experiments were performed in a custom rolling mill constructed of 316 stainless steel with a diameter of 1.37″ and a length of 4.93″. The mill was charged with 25 0.5″ balls made of 440C steel and 2 g of a 1:1 mixture of cellulose and catalyst.

(ii) Gravimetric Analysis

The extent of hydrolysis was monitored gravimetrically. Conversion of cellulose to a reaction product containing solid and/or powdered soluble and fermentable sugars was determined by stirring 0.1 g of the reaction mixture in 30 mL of water. Any oligosaccharide with a degree of polymerization <5 will be solvated. The production of water-soluble products was measured by filtration through a 47 mm diameter Whatman Nuclepore® track etched polycarbonate membrane filter with a pore size of 0.220 μm. The residue was dried in a 60.0 oven for 12 h and then weighed.

(iii) Gas Chromatography with Mass Sensitive Detection

GC-MS analysis was performed on an Agilent 6850 GC with an Agilent 19091-433E HP-5MS column (5% phenyl methyl siloxane, 30 m×250 μm×0.25 μm nom.) coupled with a 5975C VL mass selective detector. Saccharide composition was analyzed by silanizing the product. Dehydration products were extracted with 60.0 chloroform and analyzed by GC-MS.

(iv) Thin Layer Chromatography

Thin layer chromatography was used to assess the composition of the reaction product containing solid and/or powdered soluble and fermentable sugars. Solutions were spotted onto cellulose plates and developed with a 20:7:10 mixture of n-butanol, acetic acid, and water. The plates were stained with a 3% urea and 1 M phosphoric acid in n-butanol saturated water solution.

(v) Discrete Element Modeling

Discrete element models of the milling process were generated using EDEM (DEM Solutions Ltd.).

(vi) Degree of Polymerization

The degree of polymerization of the insoluble cellulose residue in the reaction product containing solid and/or powdered soluble and fermentable sugars was determined using viscometry according to the method outlined in ASTM D 4243.

(vii) Results

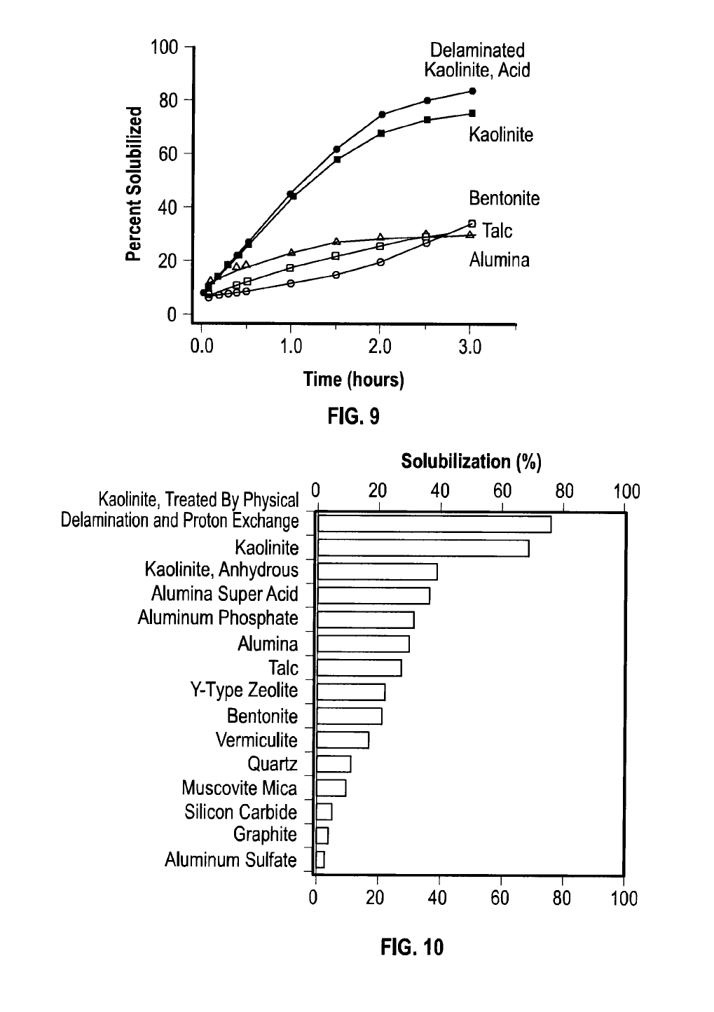

Three milling modes were investigated for the mechanocatalytic depolymerization of cellulose—shaking, rolling, and stirring. FIG. 9 illustrates solubilization achievable in a SPEX shaker mill. No appreciable solubilization was realized on samples of microcrystalline cellulose milled without a catalyst.

The catalysts' chemical and physical properties effect on conversion efficiency was studied by choosing materials with specific structural and chemical properties. FIG. 10 summarizes the solubilization results for cellulose mechanocatalytically treated for two hours in a shaker mill.

A shaker mill was chosen to assess catalyst efficacy since cellulose hydrolysis is observed after as little as 6 min of milling. This mode is a high-energy process with the possible realization of localized high pressures. After 3 h of milling, up to 84% of the cellulose can be converted to water-soluble fractions allowing rapid assessment of catalysts parameters.

The layered silicate mineral kaolinite was determined to be a good mechanocatalyst and the composition of the solubilized fraction produced was analyzed utilizing thin layer chromatography and gas chromatography with mass sensitive detection. Both methods confirmed that depolymerization occurs rapidly with no oligosaccharides larger than n=2 detected even after 30 min of treatment. The three major water-soluble components detected were levoglucosan, fructose, and glucose. The degree of polymerization of the insoluble residue was measured and found to decrease linearly with time.

The variation in product composition was studied as a function of milling mode and time. A study of the energy input through milling, and its effect on products, was investigated using a variable speed rolling-mill. Models were developed using discrete element methods (EDEM™, DEM Solutions Ltd.) to estimate the compressive forces achieved during milling. These models indicate that, in a 10 s period, a shaker mill can produce 9 impacts with forces between 400 and 3000 N; an attrition mill can produce 9 impacts between 400 and 2000 N; a rolling mill at 30 rpm generates 4 impacts between 60 and 110 N; and at 100 rpm, 10 impacts between 60 and 130 N.

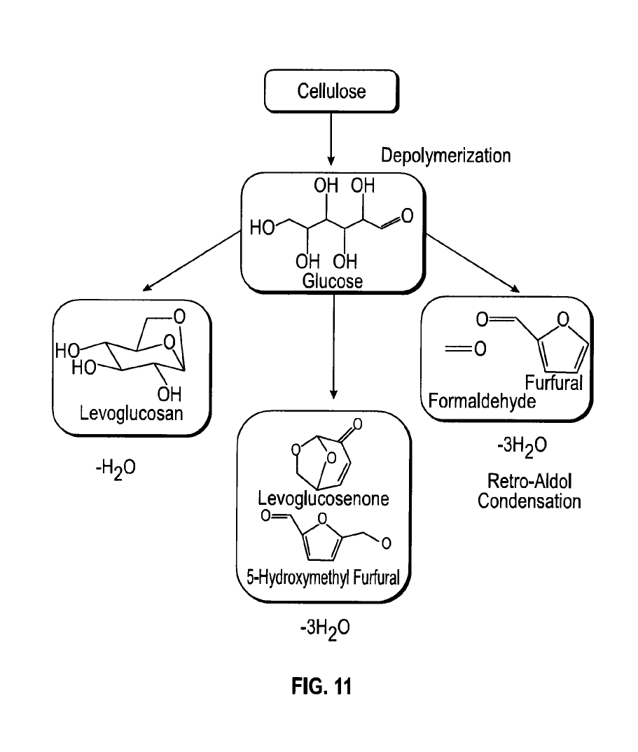

High-energy processing in a shaker mill resulted in the production of levoglucosan, fructose and glucose with a ratio of 9:1:4.3 after 30 min of treatment and a ratio of 4.6:1:4.1 after two hours of treatment. The product distribution was similar for samples prepared in an attrition mill. Low-speed processing in a rolling mill (30 rpm) resulted in no measurable catalytic activity; increasing the rotation velocity to 100 rpm resulted in 13.2±0.8% solubilization after 96 h of treatment. The product consisted of levoglucosan, fructose, and glucose in a 1:1:5.8 ratio. With continued high energy milling, the levoglucosan fraction decreased and other dehydration products were observed—levoglucosenone and 5-hydroxymethyl furfural (HMF), as well as the retro-aldol condensation product furfural (FIG. 11).

Milling alone (without a catalyst present) is not sufficient to hydrolyze the glycosidic bond in cellulose. Acidic solids such kaolinite (Al₂Si₂O₇.2H₂O), alumina super acid, aluminium phosphate (AIPO₄), alumina (Al₂O₃), Y-type zeolite, and bentonite (Al₂Si₄O₁₁.H₂O) showed good catalytic ability. Low-acidity solids such as talc (H₂Mg₃(SiO₃)₄), vermiculite ((MgFe,Al)₃(Al,Si)₄O₁₀(OH)₂.4H₂O), quartz (SiO₂), mica (KF)₂(Al₂O₃)₃(SiO₂)₆(H₂O), silicon carbide (SiC), graphite (C), and aluminium sulfate (Al₂(SO₄)₃) were less effective. The hardness of the catalyst did not play a role in the efficiency of the depolymerization. Both kaolinite and talc are soft, but kaolinite is a much more efficient catalyst. Silicon carbide and aluminium oxide are both very hard, but silicon carbide showed little or no catalytic ability. The use of harder catalysts resulted in undesirable wear on the container and milling media.

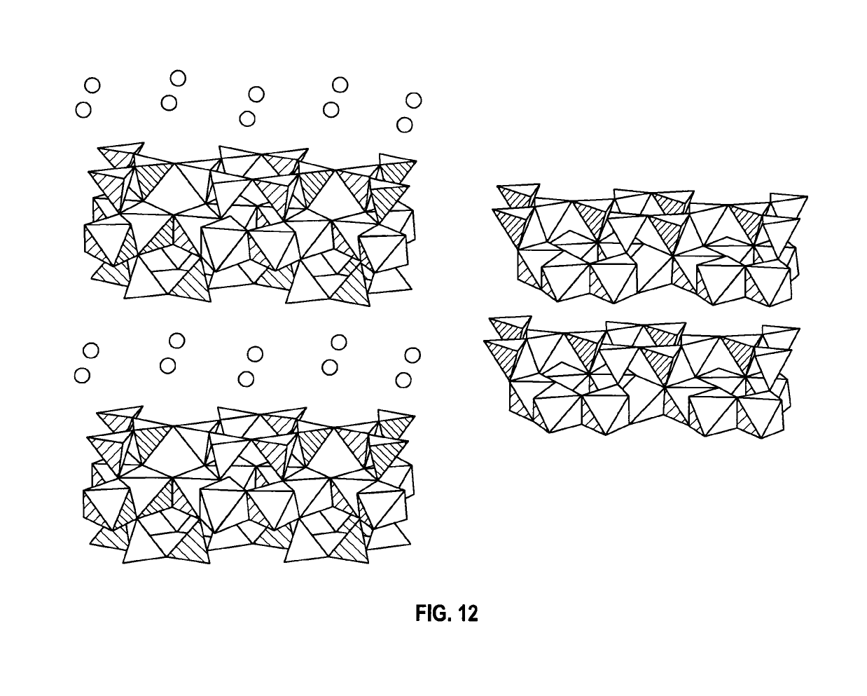

The most effective catalyst is the layered mineral kaolinite. Kaolinite is an aluminosilicate consisting of aluminium-containing (as AlO₆ units) layers covalently bound to silicon-containing (as SiO₄ units) layers as in a 1:1 ratio. These layers are held together by hydrogen bonds from protons on open Al—O—Al sites to open Si—O—Si sites. The structurally similar bentonite has each aluminium-containing layer covalently bound above and below by a silicon-containing layer in a 2:1 configuration; this prevents the active sites from interacting with the cellulose (FIG. 12). The role of aluminium in the active sites was confirmed by comparing the catalytic ability of quartz and aluminium phosphate. These compounds are isostructural; substituting the SiO₄ units in quartz with AlO₄ and PO₄ units, as in aluminium phosphate, results in an increase in active sites and the observed increase in catalytic ability.

Layered compounds are effective mechanocatalysts because the layers are typically held together by weak forces such as hydrogen bonding and van der Waals forces. These bonds can be easily broken via mechanical processing (grinding or rubbing). The result is a material with a high specific surface area (SSA) that is only dependent upon the number of layers in each particle.

Concentrations in chemical reaction are typically expressed in terms of moles/I. In a solventless, solid-solid reaction this expression is meaningless. If percent composition is used, the resulting expression does not accurately reflect the consequences of increasing the milling load without increasing the vessel size (which results in a decrease in reaction rate). We have found that reaction rates can be examined by expressing the concentration of reactants and products in terms of mass/free volume. Here the free volume is the volume of the milling container not occupied by balls, reactants, or products. This value is calculated by converting the masses of the reactants, products, and milling media to volumes based on the materials' densities. This volume is subtracted from the container volume to give a free volume. This approach indirectly incorporates the motions available to the milling media. The milling media, for the same mode of milling, in systems with large free volumes will have a greater mean free path than in systems with small free volumes.

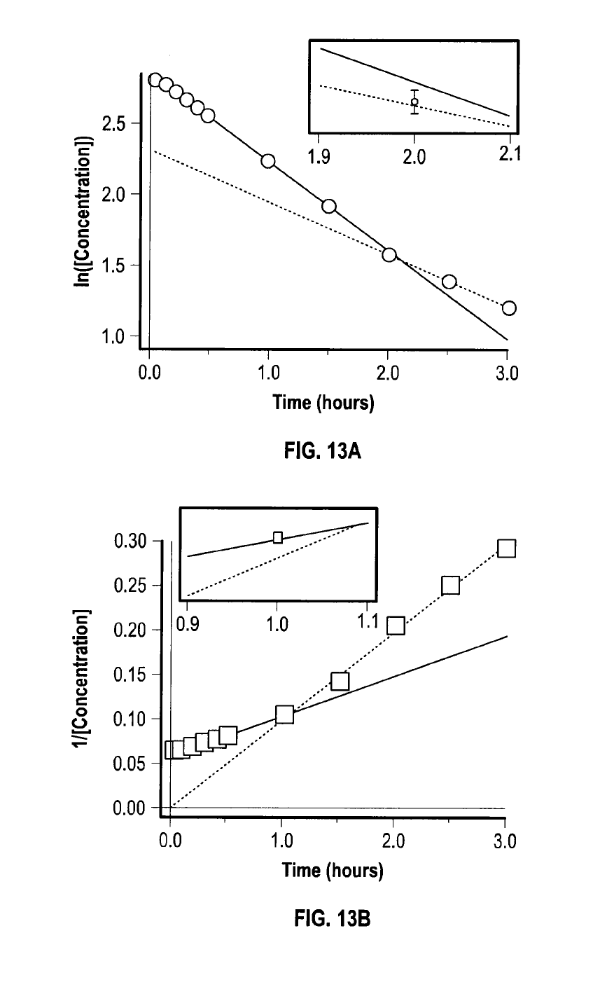

We determined the reaction order by generating kinetic plots. Although attrition is quite rapid in a SPEX mill, finely ground cellulose (Avicel™) and catalysts were used to minimize the effect of initial particle size. The reaction cannot be zeroth order since reaction rate would be independent of concentration. The concentration of the reactants directly affects the free volume and, subsequently, the motion of the milling media. Higher concentrations result in less motion. In the most severe case, the concentration would be so high that no media motion is allowed. A zeroth order model would predict yield in this case—an unphysical prediction. FIG. 13 compares a first and second order plot in this system. The differentiation between first and second order behavior is a little more subtle. Both kinetic plots can be fit to lines representing initial and final kinetics. Although the first order plot gives slightly better linear correlation coefficients, a second order model more accurately describes the data. For example, using H+ exchanged, physically delaminated kaolin the linear correlation coefficient for the initial kinetics is −0.9986 for first order kinetics and 0.9974 for second order kinetics. In the final kinetic region this coefficient is −0.9969 for first order kinetics and 0.9952 for second order kinetics. The important feature is the data point near the intersection of the two regression lines (inset FIG. 13). It does not fall on the first order curve that would be generated by the sum of the two linear fits. It does fall on the curve generated by the two linear second order fits.

It was confirmed that the process was catalytic by performing turnover studies using kaolinite and cellulose in a shaker mill. Two hours of milling time resulted in loss of catalytic efficiency over 5 turnovers. One hour of milling resulted in no loss in catalytic efficacy over 8 turnovers. Although extended milling can induce significant defects in the crystal structure of the catalysts, the active sites on these catalysts are surface protons and should be unaffected by the defect structure of the solid. Prolonged milling may, instead, result in the formation of insoluble polymerization products. In particular, furfural polymerizes when heated in the presence of an acid. These insoluble by-products would interfere with the interaction between the catalyst and the reactant. Limiting the milling time limits the production of these by-products.

In order to understand the mechanism of cellulose depolymerization, the degree of polymerization (DP) of the insoluble residue was measured. This can be compared to the change in DP observed in acid and enzyme hydrolysis. The three approaches to depolymerization-acid, enzymatic, and mechanocatalytic proceed by quite different kinetics and mechanisms. By examining the change in degree of polymerization of the residue with respect to the fraction of oligomers with a DP<5 (or degree of solubilization) the role of these factors can be reduced and the approaches can be compared.

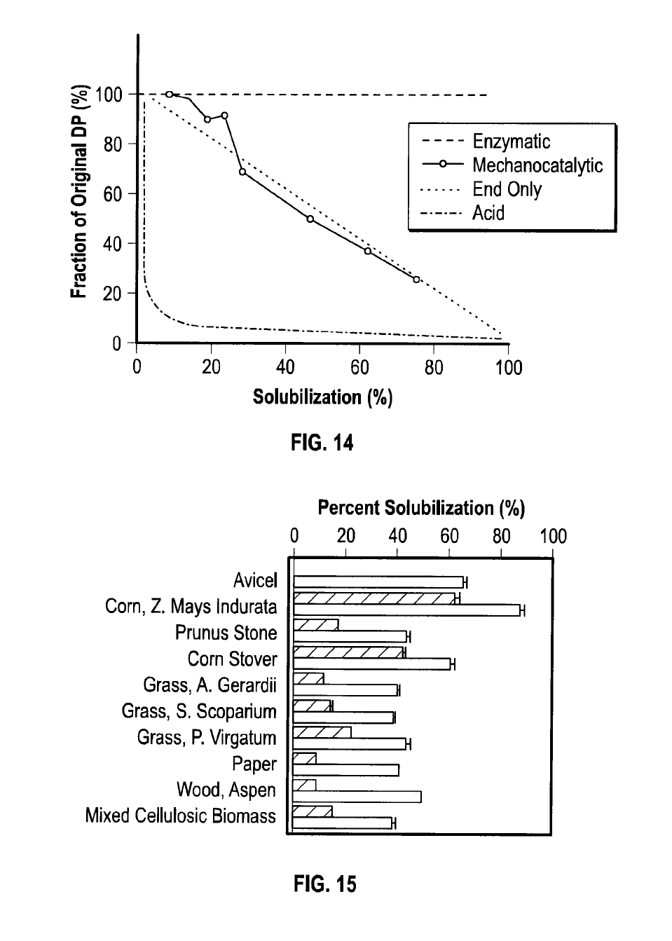

FIG. 14 shows the change in DP as a function of degree of solubilization. Values for acid hydrolysis were simulated using a model that all bonds have an equal probability of cleavage. Change in DP from enzyme hydrolysis was taken from the literature. It can be seen that mechanocatalytic depolymerization does not follow a mechanism like acid or enzyme hydrolysis. Mechanocatalytic hydrolysis does not randomly cleave cellulose chains like acid hydrolysis. Initially, depolymerization more closely matches the enzymatic process. The accessibility of surface sites gives rise to the evolution of the degree of polymerization in enzyme hydrolysis. Similarly, mechanocatalysis is dominated by two processes-attrition and hydrolysis. During the initial milling time, cellulose particles are being broken down physically and chemically.

There are three main chemical reactions occurring. The reactions are: hydrolysis catalyzed by the catalyst's surface protons, dehydration by the catalyst, and retro-aldol condensation due to the localized high pressures. The surfaces of these particles are accessible to the catalyst. At a certain point, attrition slows and only the end units of the cellulose chain are accessible. This results in a change in DP that coincides with a model where only the ends of a polymer chain are allowed to react (dashed line in FIG. 14). For the layered catalysts, bentonite, talc, and kaolinites, the rate changes when solubilization is between 30 and 40%. This corresponds to the region in FIG. 6 where the DP of the residue matches an end-only hydrolysis model and further corroborates the second-order model.

In order for mechanocatalysis to be an effective industrial tool, it must be effective for real world materials. We tested the conversion efficiency for a wide range of relevant cellulose sources. FIG. 15 illustrates the efficiency observed in the depolymerization of cellulose after two hours of milling in a mixer mill. Initial particle size was kept to less than 2 cm. In all cases, the cellulose source and catalyst were reduced to fine powders in 5 to 10 min due to the vigorous nature of the attrition process. Agricultural wastes from corn (corn stover), wood (aspen), and fruit (Prunus stone) production were examined. All showed improved water solubility after mechanocatalytic treatment. Commercial and residential waste such as paper and mixed waste from clearing land can also be efficiently treated. The grasses A. gerardii (Big Bluestem), S. scoparium (Little Bluestem) and P. virgatum (Switch grass) are crops that are of interest for use as a biomass source. It should be noted that 90% of a corn kernel's mass can be converted to soluble matter in a single pass.

Our survey experiments have utilized a SPEX mixer mill, which allows us to rapidly assess the viability of catalytic materials and develop kinetic models for cellulose conversion. We have found that the reaction goes as a second-order process in cellulose. Rolling-mode and stirring-mode are among the scalable approaches. Utilizing our DEM model, it was determined that rolling mills do not develop the high pressures encountered in a shaking mill. Processing in a rolling mill produced a product composed primarily of glucose. This suggests that the forces that occur during the milling process are directly related to the composition of the soluble fraction produced. Low forces result in no observable solubilization; increasing the rotational velocity of the roller mill results in compressive forces and a measurable yield of sugars. The most energetic process, shaking-mode, results in an increase in the levoglucosan fraction. This implies that there is a critical energetic region favorable for the production of fructose and glucose.

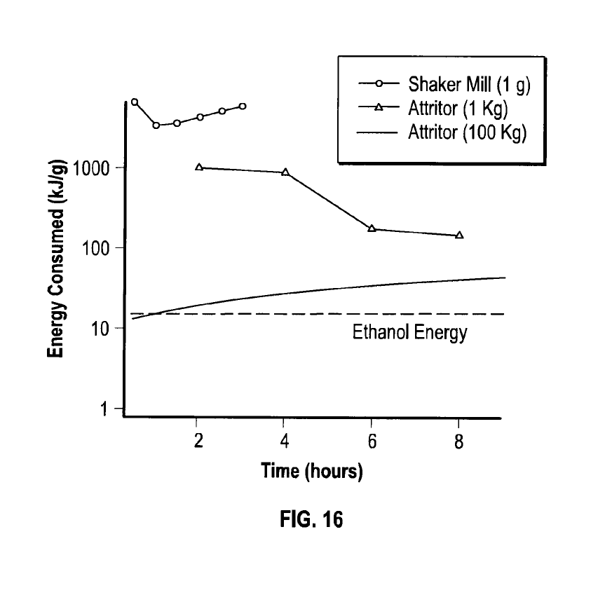

Attritors are scalable, can be run in a batch or continuous mode, and can produce compressive forces similar to those achieved in a shaker mill (0.4 to 3 GPa, as predicted by our DEM models). We performed a limited number of kilogram-scale tests using a small Union Process attritor. FIG. 16 illustrates the energy costs associated with the two milling technologies. The dashed line is the energy obtainable from the ethanol one gram of glucose. It can be seen that the SPEX mill is an energy intensive process. Switching to an attritor allowed the process to be scaled-up by 1000 fold; the result was nearly a 46-fold decrease in the energy consumption as expressed in kJ/gram glucose produced. It was found that conversion in a small attritor required a 4-hour initiation time before the rate became appreciable. The kinetic data from this batch was used, in conjunction with the behavior observed in the shaker mill, to develop a predictive model for a 100 kg batch. The gray trace in FIG. 16 shows the projected energy consumption for an attritor with a 150 hp motor and fast reaction kinetics. It is important to note that the four-hour induction period must be eliminated for this approach to produce glucose at an energy cost lower than the energy released by burning the ethanol prepared from the glucose. This process is energy positive for 0.9 h of milling with a predicted conversion efficiency of 20.2%.

The observation of the glucose dehydration products levoglucosan, levoglucosenone, and 5-hydroxymethylurfural, as well as the retro-aldol condensation product furfural, suggest that mechanocatalysts can be used for the direct conversion of cellulose into these compounds. In fact, many of the synthetic pathways utilized to produce derivatives from these compounds are now directly accessible through solventless milling.

Mechanocatalytic processing of materials has significant advantages over current methods. The best catalyst so far, kaolinite, costs around $80/ton and can be reused. Any catalyst waste produced is innocuous and there are no toxic solvents needed. Additionally, no heating or high-pressure equipment is required, simplifying plant design. Mechanocatalytic conversion of cellulose is insensitive to lignin and hemicellulose content allowing any cellulosic biomass source to be utilized. This is an improvement over methods that utilize edible biomass (such as corn) for ethanol production.

### Percent Solubilization

1 gram of grass (a cellulose-containing material) was combined with 1 gram of kaolinite (solid acid material). The grass was oven dried at 80° C. to a moisture content of 4% by mass. The materials were placed in a hardened 440C steel vial with 3 440C steel balls ½″ in diameter. The vial was agitated at ambient temperature in a SPEX8000D mixer mill in 0.5 hour increments with 0.5 hours allowed between each milling interval for cooling. It was found that there was no difference between milling for 2 hours continuously and interval milling. The mixture was milled for a total of 2 hours. Total solubilization was measured by extracting approximately 0.1 g of the milled material with 60 mL of distilled water and filtration through a 47 mm diameter Whatman Nuclepore® track etched polycarbonate membrane filter with a pore size of 0.220 μm. The residue was dried in an 80° C. oven for 12 hours and then weighed. From this value a total solubilization of 80±3% was determined. In comparison, 2 grams of grass without any solid acid, milled under the same conditions, exhibited a solubilization of 22±3% by mass.

Additional experiments to determine the percent solubilization of differing cellulose-containing materials were also performed according to the procedures outlined above for grass. The results of these additional experiments are shown in Table I below as percent yield as determined by gravimetric analysis, mass of material that was fermented, and the percent yield of soluble sugars in the reaction product. Fermentation was performed on enough material to yield 18 mg of sugars by gravimetric analysis. This sample was mixed with 4 mL of nutrient bath (yeast extract and peptone) and Saccharomyces cerevisiae. Carbon dioxide production was measured though fluid displacement in a manometer filled with saturated sodium chloride solution. Volumes were corrected to STP and converted to fermentable sugar using the relationship of two moles of CO₂ produced for every mole of glucose present.

TABLE I

| | | | | | Percent |
|---|---|---|---|---|---|
| Reac- | | Gravimetric | Mass of | Percent | Ferment- |
| tion | | Percent | material | Ferment- | able |
| Time in | Gravimetric | Yield | (g) | able | sugars |
| Minutes | percent yield | (StDev) | fermented | sugars | (StDev) |
| 6 | 5.67% | 0.14% | 0.6559 | 2.52% | 0.55% |
| 12 | 10.61% | 0.37% | 0.3506 | 8.83% | 0.22% |
| 18 | 14.06% | 0.29% | 0.2648 | 12.93% | 0.54% |
| 24 | 18.29% | 0.53% | 0.2039 | 17.04% | 0.55% |
| 30 | 21.82% | 0.68% | 0.1707 | 20.53% | 1.29% |
| 60 | 41.76% | 0.39% | 0.0890 | 44.96% | 2.28% |
| 90 | 59.62% | 0.64% | 0.0626 | 56.86% | 0.24% |
| 120 | 67.51% | 0.07% | 0.0553 | 70.02% | 0.92% |
| 150 | 71.73% | 0.53% | 0.0523 | 71.98% | 1.55% |
| 180 | 74.86% | 0.23% | 0.0501 | 76.82% | 1.51% |

The presently disclosed and/or claimed inventive concept(s), in various embodiments, includes components, methods, processes, systems and/or apparatus substantially as depicted and described herein, including various embodiments, subcombinations, and subsets thereof. Those of skill in the art will understand how to make and use the presently disclosed and/or claimed inventive concept(s) after understanding the present disclosure. The presently disclosed and/or claimed inventive concept(s), in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the presently disclosed and/or claimed inventive concept(s) has been presented for purposes of illustration and description. The foregoing is not intended to limit the presently disclosed and/or claimed inventive concept(s) to the form or forms disclosed herein. In the foregoing Detailed Description for example, various features of the presently disclosed and/or claimed inventive concept(s) are grouped together in one or more embodiments for the purpose of streamlining the disclosure. This method of disclosure is not to be interpreted as reflecting an intention that the claimed presently disclosed and/or claimed inventive concept(s) requires more features than are expressly recited in each claim. Rather, as the following claims reflect, presently disclosed and/or claimed inventive concept(s) lie in less than all features of a single foregoing disclosed embodiment. Thus, the following claims are hereby incorporated into this Detailed Description, with each claim standing on its own as a separate preferred embodiment of the presently disclosed and/or claimed inventive concept(s).

Moreover, though the description of the presently disclosed and/or claimed inventive concept(s) has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A reaction product produced by a non-aqueous hydrolysis reaction of a cellulose-containing material and a solid acid material.

2. A method for the production of a reaction product, comprising the step of hydrolytically reacting a solid acid material and a cellulose-containing material in a non-aqueous environment for a period of time to sufficient to produce the reaction product.

3. The reaction product of claim 1, wherein the reaction product comprises at least 70% by weight of soluble sugars selected from the group consisting of glucose, xylose, and combinations thereof.

4. The reaction product of claim 2, wherein the reaction product comprises at least 70% by weight of soluble sugars selected from the group consisting of glucose, xylose, and combinations thereof.
